(19) United States
(12) Patent Application Publication
(10) Pub. No.: US 2024/0352547 A1
(43) Pub. Date: Oct. 24, 2024

(54) IRON-CONTAINING POWDER DIRECT STEELMAKING DEVICE IN REDUCING ATMOSPHERE AND METHOD FOR USING SAME

(71) Applicant: Xiao ZHAO, Beijing (CN)

(72) Inventor: Xiao ZHAO, Beijing (CN)

(21) Appl. No.: 18/682,442

(22) PCT Filed: Nov. 8, 2021
(86) PCT No.: PCT/CN2021/129319

§ 371 Date: Feb. 9, 2024

(30) Foreign Application Priority Data
Aug. 10, 2021 (CN) 202110915559.7

(51) Int. Cl. C21B 13/00

(52) U.S. Cl. CPC C21B 13/0033; C21B 13/0006; C21B 13/0073; C21B 13/008; C21B 2300/02

(57) ABSTRACT

A direct steelmaking device for iron containing powder in a reducing atmosphere and a method for its use are provided. The device comprises a steelmaking pool, a gas making tower, a fast reduction area, an ore feeding area, and a control system. The steelmaking pool arranged at the bottom comprises a slag flux pile, the bottom of the steelmaking pool is provided with a molten steel layer, and a liquid slag layer is provided on the molten steel layer. The fast reduction area is provided above the steelmaking pool. A gas making tower is provided on one side of a lower part of the fast reduction area, and the ore feeding area is provided above the fast reduction area.

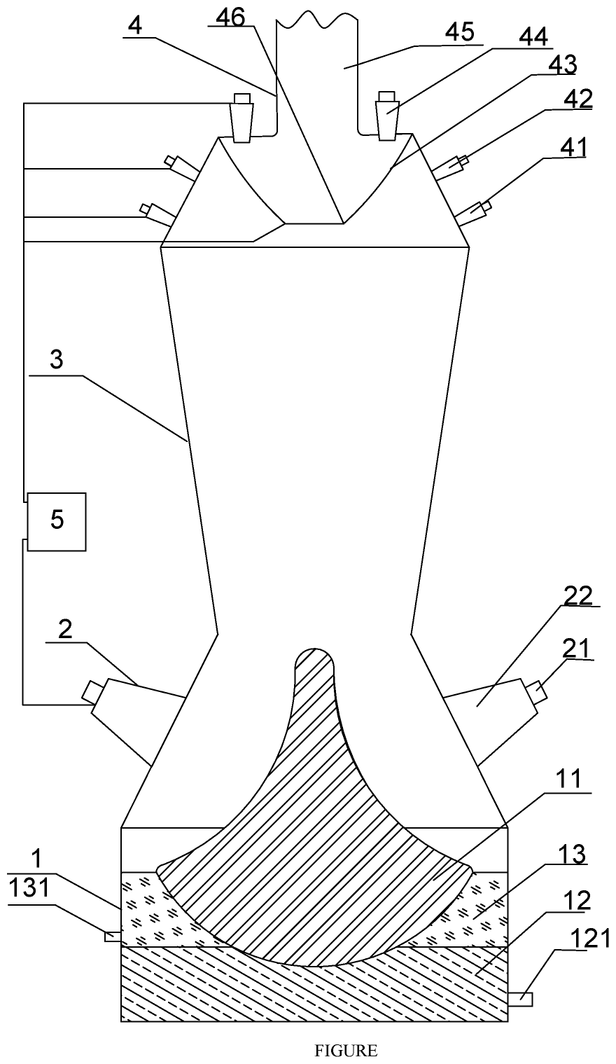

### CROSS-REFERENCE TO THE RELATED APPLICATIONS

This application is the national phase entry of International Application No. PCT/CN2021/129319, filed on Nov. 8, 2021, which is based upon and claims priority to Chinese Patent Application No. 202110915559.7, filed on Aug. 10, 2021, the entire contents of which are incorporated herein by reference.

### TECHNICAL FIELD

The present application belongs to the technical field of metallurgy, further to a direct steelmaking device for iron containing powder in a reducing atmosphere and a method for its use.

### BACKGROUND

Currently, coking and sintering/pelletizing by means of blast furnaces and converters is a main process for crude steel production, including four stages: sintering (or pelletizing), coking, blast furnace ironmaking, and converter oxidation steelmaking. This process has the disadvantages of long production process, high energy consumption, and serious environmental pollution of coke resources. Due to the global environmental pollution and resource and energy shortages are becoming increasingly severe, energy conservation and emission reduction, and clean-energy production have become a necessary path for the sustainable development of the global steel industry.

The oxygen converter and electric furnace steelmaking processes are used by the traditional steelmaking process. The oxygen converter uses blast furnace molten iron as raw material for blowing to obtain qualified molten steel, with multiple production units, a large scale, and a long production cycle. The blast furnace molten iron used in the oxygen converter has a high carbon content (generally 2.5-4.3%) and contains a lot of impurities such as silicon, manganese, phosphorus, sulfur, etc. It not only requires slag flux, but also high-purity oxygen blowing, and the transportation of molten iron will also result in heat loss. Electric furnace steelmaking mainly uses recycled scrap steel, and uses electricity as a heat source in the electric furnace to obtain qualified molten steel, with simple production process and short production cycle. A large amount of electricity is required because of the need to melt scrap steel, both of which require the construction of independent steelmaking equipment, which requires a huge investment.

In respect of the problems of high pollution and high energy consumption in traditional blast furnace ironmaking processes, melt reduction ironmaking technology has become an important technology for the steel industry to achieve energy conservation, emission reduction, and clean production in recent years, such as COREX, FINEX, and HIsmelt, as it can reduce dependence on the processes such as block making, sintering, and coking with high pollution and high energy consumption. An upper pre-reduction vertical furnace is used for iron ore pre-reduction by the COREX process to obtain metallized pellets (DRI) with a metallization rate of 70%-90%, which is then sent to the lower melting gasification furnace for final reduction. During production, lump ores, pellet ores, sintered ores, and some cokes are still needed to maintain furnace conditions. The fine ore is used as raw material by the FINEX process and a multi-stage fluidized bed reactor is used to perform iron ore pre-reduction, to obtain the reduced iron powder with a metallization rate of about 90%. After hot pressing, the reduced iron powder and fine coal are added as furnace materials to the melting gasification furnace for final reduction. The fine ore is used as the main raw material by the HIsmelt process and a cyclone melting furnace is used to melt the fine ore. The fine ore, flux, and coal powder are sprayed into the cyclone melting furnace along the tangent direction of the furnace body with oxygen as the carrier. The fine ore is reduced and melted during movement, and then flows along the furnace wall and drips into the smelting reduction furnace for final reduction.

The above processes are performed by means of different devices for reduction ironmaking and final reduction steelmaking. Firstly, the iron containing powder is reduced and compacted, and then reduced for steelmaking, which is obviously complex with a low utilization rate. Although flash smelting has a high efficiency, the cyclone melting furnace and melt reduction furnace are also with different structures. The requirement for spraying performance along the tangent direction of the furnace body to the cyclone melting furnace is very strict, the erosion of refractory materials is severe, and the service life of the furnace lining is short, which cannot be used for industrial large-scale production.

The flash ironmaking technology disclosed in patents such as CN106086280A, CN102690919A, and CN103993115A integrates processes such as reduction, melting, and slagging, and has the advantages of simplified equipment and easy large-scale production. However, the carbon content of the produced molten iron is high (>2.0%), and impurities such as Si, Mn, P, and S cannot be effectively removed, making it impossible to directly produce crude steel. A process of direct steelmaking using fine ore and coal oxygen is proposed by other patents CN101906501A and CN108374067A, in which, the iron ore powder is sprayed into the steelmaking furnace with coal powder and oxygen for steelmaking after pre-reduction. Especially in CN108374067A, the fast reduction direct steelmaking device includes an iron ore powder pretreatment system, a fast reduction furnace system, and a steelmaking furnace system. Obviously, different devices are also used for reducing iron and smelting final reduction steelmaking.

In summary, the current melt reduction ironmaking/direct steelmaking method can to some extent solve the problems of long steel production processes, high energy consumption, and high pollution. However, the above process still adopts the traditional two-step process of reduction ironmaking and oxidation steelmaking. The reduction and oxidation processes are performed in different equipment or containers, which needs high equipment investment and frequent equipment failures.

### SUMMARY

The technical problem solved by the present disclosure is that the traditional blast furnace ironmaking and converter steelmaking have high energy consumption, serious environmental pollution, and need two steps. Although there is smelting reduction ironmaking technology, it involves reducing iron and oxidizing steel through different devices, resulting in a long production process, high energy consumption, severe pollution, large equipment footprint, and low synergy rate.

To solve the above technical problems, the present disclosure provides a direct steelmaking device for iron containing powder in a reducing atmosphere, comprising a steelmaking pool, a gas making tower, a fast reduction area, an ore feeding area, and a control system;

wherein, the steelmaking pool arranged at the bottom of the device, comprises a slag flux pile, the bottom of the steelmaking pool is provided with a molten steel layer, and a liquid slag layer is provided on the molten steel layer;

the fast reduction area is provided above the steelmaking pool;

a gas making tower is provided on one side of a lower part of the fast reduction area, and the ore feeding area is provided above the fast reduction area;

an exhaust gas outlet is provided in the center of a top part of the ore feeding area, and several slag flux feeding ports are provided along the circumference on an outer side of the exhaust gas outlet, one side of the ore feeding area is uniformly provided with several cold air ports and several ore feeding ports, the interior of the ore feeding area is provided with a slag flux bin and a slag flux feeding mechanism;

the control system is provided on one side of the steelmaking pool, the gas making tower, the fast reduction area or the ore feeding area, and is electrically connected with the device by sensors and control components.

Preferably, the steelmaking pool is a cylindrical or polygonal prism cylinder, and the upper part of the steelmaking pool is directly connected with the fast reduction area, a steel outlet is provided on one side near the bottom of the molten steel layer of the steelmaking pool, and a slag outlet is provided on the other side near the molten steel layer of the liquid slag layer.

Preferably, the slag flux pile is a solid slag flux pile with an arc conical shape; the solid slag flux pile is a conical pile, formed by mixing one or more types of granular or block limestone, quicklime, blue charcoal, fluorite, dolomite, and block coal with a particle size of 5-50 mm and then naturally falling; the solid slag flux pile passes through the liquid slag layer, and suspended in the molten steel layer.

Preferably, the gas making tower is provided with a gas making gun and a reducing airflow channel, forming a conical or pyramid platform; the gas making gun is externally connected with an oxygen supply device and a gas making raw material supply device, and flame temperature of the gas making gun reaches 1800-2400° C.; an outlet of the reducing airflow channel of the gas making tower is connected with a lower part of the fast reduction area.

Preferably, the gas making raw material supply device supplies gas making raw materials, which include but are not limited to coal powder, natural gas, hydrogen, biomass fuel, etc.

Preferably, the reducing gas produced by the gas making gun contains a certain proportion of CO, H₂, and a small amount of H₂O, CO₂, and N₂.

Preferably, the main reaction of the fast reduction area is:

[FeO]+H₂ (g)=[Fe]+H₂O (g)

[FeO]+CO (g)=[Fe]+CO₂ (g)

The main reactions in the slag flux pile area are:

(SiO₂)+2(CaO)=(2CaO·SiO₂)

[FeS]+(CaO)=(CaS)+[FeO]

(P₂O₅)+4(CaO)−(4CaO·P₂O₅).

Preferably, the reducing airflow channel is bell-mouth shaped, with a downward inclination angle of 30°-60° from the horizontal plane; an inclination angle with a centripetal axis is 1°-16° to the right in a northern hemisphere and 1°-16° to the left in a southern hemisphere.

Preferably, the fast reduction area is an area for reducing iron containing powder, with a structure of a cylindrical shape with a variable cross-section that is thin in the middle and thick at the upper and lower ends; at least three gas making towers are arranged along the circumference at a lower part of the fast reduction area.

Preferably, the ore feeding area is a cone platform with a large bottom and a small top, and the exhaust gas outlet is provided in the center of the top part of the ore feeding area; at least one slag flux feeding port is arranged along the circumference on the outer side of the exhaust gas outlet; at least two ore feeding ports are provided on the outer side of the ore feeding area, and the outer side of the ore feeding area is uniformly provided with at least two cold air ports, the inner part of the ore feeding area is provided with a slag flux bin and a slag flux feeding mechanism.

Preferably, the control system comprises hardware systems and control software, which are electrically connected with the device by sensors and control components.

Preferably, the control system is electrically connected with the gas making tower, the cold air port, the ore feeding port, the slag flux feeding port, and the slag flux feeding mechanism.

A method for using the device for direct steelmaking of iron containing powder in the reducing atmosphere in any one of claims 1-8, wherein, the method comprises:
Step 1: opening the slag flux feeding port by the control system, mixing slag flux materials and loading into the slag flux bin, the slag flux materials enter the steelmaking pool from the slag flux bin, forming the slag flux pile with a height of 1-3 m at the bottom;
Step 2: drying gas making raw materials with an average particle size less than 0.1 mm to a moisture content of ≤1 wt. %, then loading into a gas making raw material supply device;
Step 3: starting a gas making gun through an ignition device of the gas making gun, adjusting an oxygen supply device and the gas making raw material supply device to make CO+H₂>90% in gas composition and the temperature>1800° C.;
Step 4: drying the iron containing powder to a moisture content of ≤1 wt. %, then feeding through an ore feeding port, the iron containing powder has a particle size of <1 mm, an average particle size of 0.074 mm, and a total iron TFe content of 50-70 wt. %;
Step 5: performing heat and mass transfer reactions of the iron containing powder with rising reducing gas generated by the gas making gun in the fast reduction area when falling into the device, and then falling into a surface of the slag flux pile in the steelmaking pool, further reducing unreduced part of the iron containing powder in the fast reduction area on the surface of the slag flux pile with the reducing gas generated by the gas making gun;
Step 6: reducing molten iron with the reducing gas finally, and removing impurities with the slag flux pile to generate final slag, to separate the slag and steel;
Step 7: regularly discharging the molten steel and the slag through a steel outlet and a slag outlet, and discharging the generated exhaust gas promptly through the exhaust gas outlet.

Preferably, the surface of the slag flux pile in step 1 is an inner concave arc surface, and the soft melted steel slag mixture flows slowly from the top of the pile along the arc surface to the bottom of the pile under the action of gravity, and undergoes heat and mass exchange through reverse convection with high-temperature reducing gas; when the steel slag mixture flows downwards, it reacts with the slag flux on the surface of the slag flux pile to remove impurities such as sulfur and phosphorus from the steel liquid, generating high alkalinity final slag.

Preferably, the molten steel in step 7 is C: <0.5 wt. %, S: <0.02 wt. %, P: <0.02 wt. % of crude steel; the binary alkalinity of the slag liquid is 1.3-2.0.

The above technical solution provided by the embodiments of the present disclosure has at least the following beneficial effects:

In the above solutions, the iron containing powder is directly used to make steel in a reducing atmosphere, which abandons the traditional process flow of coking, sintering, and pelletizing in blast furnaces, as well as the method of converter steelmaking. Instead, the iron containing powder is directly used as the raw material, and a reduction reaction occurs with the reducing gas in the fast reduction area. A small amount of unreduced iron oxide is reduced finally in the slag flux pile, while completing impurity removal reactions such as desulfurization and dephosphorization. Thus, the crude steel can be directly and efficiently produced within one device, without the dependence on coke resources, reducing high energy consuming processes. There is no need for a large number of steelmaking facilities, saving a lot of capital investment.

The iron containing powder is directly used for steelmaking in a reducing atmosphere. The gas making raw materials need to be sprayed with high-temperature reducing gas through the gas making gun. The high-temperature reducing gas first acts directly on the slag flux pile and the steel slag mixture flows downwards along the slag flux pile, providing heat to the steel slag mixture and slag flux pile, which is beneficial for increasing the temperature of the steel slag mixture, melting lime, shortening the stagnation period, accelerating the slag making process, and reducing heat loss. Then the high-temperature reducing gas rises through the fast reduction area, where it encounters the falling iron containing powder in a countercurrent manner. At the same time, it undergoes heat and mass transfer reactions, with sufficient contact reactions and high reaction efficiency.

The iron containing powder is directly used to make steel in a reducing atmosphere, and a steelmaking pool is arranged at the bottom of the furnace. After the reduction reaction, the falling iron and iron ore soft melt fall together on the surface of the slag flux pile. The unreduced part of the iron containing powder in the fast reduction area can be further reduced with high-temperature reducing gas to complete the final reduction of the steel slag mixture. It undergoes dephosphorization, desulfurization, and other impurity removal reactions with the slag flux, to generate final slag and separate slag and steel. Thus, this process can realize direct steelmaking in one device without the need for a large investment in steelmaking equipment and greatly save funds and occupation area.

Therefore, the present disclosure combines reduction and slagging of the iron containing powder in the fast reduction area and the slag flux pile, and uniquely designs the structure and process for the direct steelmaking device, which creates a flow field and a temperature field that is beneficial to heat and mass transfer inside the device. Therefore, the goal of integrated direct steelmaking is achieved in a reducing atmosphere based on the slag flux pile inside the device.

In summary, the smelting process of the present disclosure relies on a slag flux pile in the steelmaking pool, and the slag flux is sufficient and excessive throughout the smelting process. Impurities such as sulfur and phosphorus, as well as acidic oxides that need to be removed, undergo various chemical reactions on the surface of excess slag flux (alkaline oxide) pile to generate final slag with a low melting point, which is discharged into the steelmaking pool.

### BRIEF DESCRIPTION OF THE DRAWINGS

In order to provide a clearer explanation of the technical solution in the embodiments of the present disclosure, a brief introduction will be made to the accompanying drawings required in the description of the embodiments. It is evident that the accompanying drawings are only some embodiments of the present disclosure. For those skilled in the art, other accompanying drawings can be obtained based on these drawings without creative labor.

The figure is a schematic diagram of the structure of the direct steelmaking device for iron containing powder in a reducing atmosphere of the present disclosure.

In which:
1. Steel making pool; 11. Slag flux pile; 12. Molten steel layer; 121. Steel outlet; 13. Liquid slag layer; 131. Slag outlet;
2. Gas making tower; 21. Gas making gun; 22. Reducing airflow channel;
3. Fast reduction area;
4. Ore feeding area; 41. Cold air port; 42. Ore feeding port; 43. Slag flux bin; 44. Slag flux feeding port; 45. Exhaust gas outlet; 46. Slag flux feeding mechanism;
5. Control system.

### DETAILED DESCRIPTION OF THE EMBODIMENTS

To clarify the technical problems, solutions, and advantages to be solved by the present disclosure, a detailed description will be provided below in conjunction with the accompanying drawings and specific embodiments.

As shown in the figure, an embodiment of the present disclosure provides a direct steelmaking device for iron containing powder in a reducing atmosphere. The device comprises a steelmaking pool 1, a gas making tower 2, a fast reduction area 3, an ore feeding area 4, and a control system 5. The steelmaking pool 1 is located at the bottom of the device, and the steelmaking pool 1 includes a slag flux pile 11 arranged in the center. The bottom of the slag flux pile 11 is provided with a molten steel layer 12. The upper layer of the molten steel layer 12 is provided with a liquid slag layer 13, the top of the slag flux pile 11 is provided with a fast reduction area 3, one side of the lower part of the fast reduction area 3 is provided with a gas making tower 2, and the top of the fast reduction area 3 is provided with an ore feeding area 4. The control system 5 controls the measurement and control units distributed in different parts by electrical connections.

The steelmaking pool 1 is a cylindrical or polygonal prism cylinder, and the upper part of the steelmaking pool 1 is directly connected with the fast reduction area 3. At least one steel outlet 121 is provided on one side near the bottom of the molten steel layer 12 of the steelmaking pool 1, and at least one slag outlet 131 is provided on the other side near the molten steel layer 121 of the liquid slag layer 13.

The slag flux pile 11 is a solid slag flux pile with an arc conical shape. The solid slag flux pile is a conical pile with a height of 1-3 m, formed by mixing one or more types of granular or block limestone, quicklime, blue charcoal, fluorite, dolomite, and block coal with a particle size of 5-50 mm and then naturally falling. The solid slag flux pile is preferably made of granular limestone with a particle size of 20 mm, block quicklime with a particle size of 30 mm, granular blue charcoal with a particle size of 15 mm, block blue charcoal, fluorite, dolomite, and coal with a particle size of 40 mm, and granular limestone, raw stone ash, blue charcoal, and fluorite with a particle size of 33 mm. The preferred heights for conical pile are 1.5 m, 2.5 m, 1 m, and 3 m.

The gas making tower 2 is provided with a gas making gun 21 and a reducing airflow channel 22, forming a conical platform. The gas making gun 21 is externally connected with an oxygen supply device and a gas making raw material supply device. The flame temperature of the gas making gun 21 reaches 1800-2400° C., preferably 1800° C., 2000° C., 2200° C., and 2400° C. The gas making gun 21 sprays the flame of the gas making raw materials inward, generates high-temperature reducing gas through incomplete combustion, and directly sprays onto the side of the slag flux pile 11. The outlet of the reducing airflow channel 22 of the gas making tower 2 is connected with a lower part of the fast reduction area 3.

The gas making raw material supply device supplies the gas making raw materials, which include but are not limited to coal powder, natural gas, hydrogen, biomass fuel, etc.

The reducing gas produced by the gas making gun 21 contains a certain proportion of CO, H₂, and a small amount of H₂O, CO₂, and N₂.

The reducing airflow channel 22 is bell-mouth shaped, with a downward inclination angle of 30°-60° from the horizontal plane, preferably 45°, 40°, 50°, 30°, and 60°. An inclination angle with a centripetal axis is 1°-16° to the right in a northern hemisphere and 1°-16° to the left in a southern hemisphere, preferably 8°, 11°, and 5°.

The fast reduction area 3 is an area for reducing the iron containing powder, with a structure of a cylindrical shape with a variable cross-section that is thin in the middle and thick at the upper and lower ends. The shape of the variable cross-section is used to control the flow field to operate according to the set parameters. A lower part of the fast reduction area 3 is uniformly provided with 3-36 gas making towers along the circumference.

The ore feeding area 4 is a cone platform with a large bottom and a small top, and the exhaust gas outlet 45 is provided in the center of the top part of the ore feeding area 4. 1-3 slag flux feeding ports 44 are arranged along the circumference on the outer side of the exhaust gas outlet. 2-16 ore feeding ports 42 are uniformly arranged on the outer side of the ore feeding area 4. 2-18 cold air ports 41 are uniformly arranged on the outer side of the ore feeding area 4 for introducing cold gas and controlling the exhaust gas temperature within the set range. There are slag flux bins 43 and slag flux injection mechanisms 46 inside the ore feeding area 4.

The control system 5 comprises hardware systems and control software, which are electrically connected with the device by sensors and control components.

The embodiments of the present disclosure provide a method for using the device for direct steelmaking of iron containing powder in the reducing atmosphere, comprising:
Step 1: opening the slag flux feeding port 44 by control system 5, mixing slag flux materials and loading into the slag flux bin 43, and controlling the slag flux feeding mechanism 46 to allow the slag flux materials to enter the steelmaking pool 1 from the slag flux bin 43, forming a slag flux pile 11 at the bottom;
Step 2: drying gas making raw materials with an average particle size less than 0.1 mm to a moisture content of ≤1 wt. %, then loading into a gas making raw material supply device;
Step 3: starting a gas making gun 21 through an ignition device of the gas making gun 21, adjusting the oxygen supply device and the gas making raw material supply device to make CO+H₂>90% in gas composition and the temperature>1800° C.;
Step 4: drying the iron containing powder to a moisture content of ≤1 wt. %, then feeding through an ore feeding port 42, the iron containing powder has a particle size of <1 mm, an average particle size of 0.074 mm, and a total iron TFe content of 50-70 wt. %;
Step 5: the iron containing powder falls into the device and undergoes heat and mass transfer reactions with the reducing gas produced by the rising gas making gun 21 in the fast reduction area 3, and then falls into the surface of the slag flux pile 11 in the steelmaking pool 1. The unreduced part of the iron containing powder in the fast reduction area 3 is further reduced on the surface of the slag flux pile 11 with the reducing gas produced by the gas making gun 21;
Step 6: performing the final reduction of the steel slag mixture, reacting with the slag flux pile 11 to remove impurities, to generate the final slag, and then separating slag and steel;
Step 7: regularly discharging the molten steel and the slag through the steel outlet 121 and the slag outlet 131, and discharging the generated exhaust gas promptly through the exhaust gas outlet 45, and adjusting the exhaust gas temperature by introducing cold air through the cold air outlet 41.

The surface of the slag flux pile 11 in step 1 is an inner concave arc surface, and the soft melted steel slag mixture flows slowly from the top of the reactor along the arc surface to the bottom of the pile under the action of gravity, and undergoes heat and mass exchange through reverse convection with high-temperature reducing gas; when the steel slag flows downwards, it reacts with the slag flux on the surface of the slag flux pile 11 to remove impurities such as sulfur and phosphorus from the steel liquid, generating high alkalinity final slag.

The steel in step 7 is C: <0.5 wt. %, S: <0.02 wt. %, P: <0.02 wt. % of crude steel. The binary alkalinity of the slag liquid is 1.3-2.0.

In the above embodiments, the iron containing powder is directly used to make steel in a reducing atmosphere, which abandons the traditional process flow of coking, sintering, and pelletizing in blast furnaces, as well as the flash smelting method. Instead, the iron containing powder is directly used as raw material, and a reduction reaction occurs with the reducing gas in the fast reduction area. A small amount of unreduced iron oxide is reduced finally in the slag flux pile, while performing impurity removal reactions such as desulfurization and dephosphorization. Thus, the crude steel can be directly and efficiently produced within one device, without dependence on coke resources, reducing high energy consuming processes. There is no need for a large number of steelmaking facilities, saving a lot of capital investment.

The iron containing powder is directly used to make steel in a reducing atmosphere. The gas making raw materials need to be sprayed with the high-temperature reducing gas through the gas making gun. The high-temperature reducing gas first acts directly on the slag flux pile, providing heat for the slag flux pile, which is beneficial to the melting of lime, shortening the stagnation period, accelerating the slag making process, and reducing heat loss; Then the high-temperature reducing gas rises through the fast reduction area, and encounters the falling iron containing powder in a countercurrent manner. At the same time, it undergoes heat and mass transfer reactions, with sufficient contact reactions and high reaction efficiency.

The iron containing powder is directly used to make steel in a reducing atmosphere, and a steelmaking pool is arranged at the bottom of the furnace. After the reduction reaction, the falling iron and iron ore soft melt fall together on the surface of the slag flux pile. The unreduced part of the iron containing powder in the fast reduction area can be further reduced with high-temperature reducing gas to generate molten iron. Finally, all iron oxides and high-temperature reducing gas will complete the final reduction, and dephosphorization will be completed with the slag flux Desulfurization and other impurity removal reactions generate final slag, to separate slag and steel, which makes direct steelmaking in one device without the need for a large investment in steelmaking device, greatly saving funds and occupation area.

In summary, the smelting process of the present disclosure relies on a slag flux pile in the steelmaking pool, and the slag flux is sufficient and excessive throughout the smelting process. Impurities such as sulfur and phosphorus, as well as acidic oxides that need to be removed, undergo various chemical reactions on the surface of excess slag flux (alkaline oxide) pile to generate final slag with a low melting point, which is discharged into the steelmaking pool. The unique design of the structure and process of direct steelmaking device combines the reduction and slag making of the iron containing powder in the fast reduction area and slag flux pile, which creates a flow field and temperature field conducive to heat and mass transfer within the device. Therefore, the goal of integrated direct steelmaking is achieved in a reducing atmosphere based on the slag flux pile inside the device.

The above is preferred embodiments of the present disclosure. It should be pointed out that for those skilled in the art, several improvements and embellishments can be made without departing from the principles of the present disclosure, and these improvements and embellishments should also be considered within the protection scope of the present disclosure.

What is claimed is:

1. A direct steelmaking device for iron containing powder in a reducing atmosphere, comprising a steelmaking pool, a gas making tower, a fast reduction area, an ore feeding area, and a control system;
wherein the steelmaking pool arranged at a bottom of the direct steelmaking device, comprises a slag flux pile, a bottom of the steelmaking pool is provided with a molten steel layer, and a liquid slag layer is provided on the molten steel layer;
the fast reduction area is provided above the steelmaking pool;
the gas making tower is provided on one side of a lower part of the fast reduction area, and the ore feeding area is provided above the fast reduction area;
an exhaust gas outlet is provided in a center of a top part of the ore feeding area, and a plurality of slag flux feeding ports are provided along a circumference on an outer side of the exhaust gas outlet, one side of the ore feeding area is uniformly provided with a plurality of cold air ports and a plurality of ore feeding ports, an interior of the ore feeding area is provided with a slag flux bin and a slag flux feeding mechanism;
the control system is provided on one side of the steelmaking pool, the gas making tower, the fast reduction area or the ore feeding area, and is electrically connected with the direct steelmaking device by sensors and control components.

2. The direct steelmaking device for the iron containing powder in the reducing atmosphere according to claim 1, wherein the steelmaking pool is a cylindrical or polygonal prism cylinder, and an upper part of the steelmaking pool is directly connected with the fast reduction area, a steel outlet is provided on a first side near a bottom of the molten steel layer of the steelmaking pool, and a slag outlet is provided on a second side near the molten steel layer of the liquid slag layer.

3. The direct steelmaking device for the iron containing powder in the reducing atmosphere according to claim 1, wherein the slag flux pile is a solid slag flux pile with an arc conical shape; the solid slag flux pile is a conical pile, formed by mixing at least one type of granular or block limestone, quicklime, blue charcoal, fluorite, dolomite, and block coal with a particle size of 5-50 mm and naturally falling; the solid slag flux pile passes through the liquid slag layer, and suspended in the molten steel layer.

4. The direct steelmaking device for the iron containing powder in the reducing atmosphere according to claim 1, wherein the gas making tower is provided with a gas making gun and a reducing airflow channel, forming a conical or pyramid platform;
the gas making gun is externally connected with an oxygen supply device and a gas making raw material supply device, and flame temperature of the gas making gun reaches 1800-2400° C.; an outlet of the reducing airflow channel of the gas making tower is connected with the lower part of the fast reduction area.

5. The direct steelmaking device for the iron containing powder in the reducing atmosphere according to claim 4, wherein the reducing airflow channel is bell-mouth shaped, with a downward inclination angle of 30°-60° from horizontal plane; an inclination angle with a centripetal axis is 1°-16° to right in a northern hemisphere and 1°-16° to left in a southern hemisphere.

6. The direct steelmaking device for the iron containing powder in the reducing atmosphere according to claim 1, wherein the fast reduction area is an area for reducing iron containing powder, with a structure of a cylindrical shape with a variable cross-section, wherein the structure of the cylindrical shape is thin in middle and thick at upper and lower ends; at least three gas making towers are arranged along a circumference at the lower part of the fast reduction area.

7. The direct steelmaking device for the iron containing powder in the reducing atmosphere according to claim 1, wherein the ore feeding area is a cone platform with a large bottom and a small top, and the exhaust gas outlet is provided in the center of the top part of the ore feeding area; the plurality of slag flux feeding ports are arranged along the circumference on the outer side of the exhaust gas outlet; at least two ore feeding ports are provided on an outer side of the ore feeding area, and the outer side of the ore feeding area is uniformly provided with at least two cold air ports, the interior of the ore feeding area is provided with the slag flux bin and the slag flux feeding mechanism.

8. The direct steelmaking device for the iron containing powder in the reducing atmosphere according to claim 1, wherein the control system comprises hardware systems and control software, the hardware systems and control software are electrically connected with the direct steelmaking device by the sensors and the control components.

9. A method for using the direct steelmaking device for the iron containing powder in the reducing atmosphere in claim 1, wherein the method comprises:
step 1: opening the slag flux feeding port by the control system, mixing slag flux materials and loading into the slag flux bin, the slag flux materials enter the steelmaking pool from the slag flux bin, forming the slag flux pile with a height of 1-3 m at the bottom of the steelmaking pool;
step 2: drying gas making raw materials with an average particle size less than 0.1 mm to a moisture content of ≤1 wt. %, loading into a gas making raw material supply device;
step 3: starting a gas making gun through an ignition device of the gas making gun, adjusting an oxygen supply device and the gas making raw material supply device to make CO+H₂>90% in gas composition and temperature>1800° C.;
step 4: drying the iron containing powder to a moisture content of <1 wt. %, feeding through the ore feeding port, the iron containing powder has a particle size of <1 mm, an average particle size of 0.074 mm, and a total iron TFe content of 50-70 wt. %;
step 5: performing heat and mass transfer reactions of the iron containing powder with rising reducing gas generated by the gas making gun in the fast reduction area when falling into the direct steelmaking device, and falling into a surface of the slag flux pile in the steelmaking pool, further reducing unreduced part of the iron containing powder in the fast reduction area on the surface of the slag flux pile with the reducing gas generated by the gas making gun;
step 6: reducing molten iron with the reducing gas, and removing impurities with the slag flux pile to generate slag, to separate slag and steel;
step 7: regularly discharging molten steel and the slag through a steel outlet and a slag outlet, and discharging generated exhaust gas promptly through the exhaust gas outlet.

10. The method according to claim 9, wherein the molten steel in step 7 is C: <0.5 wt. %, S: <0.02 wt. %, P: <0.02 wt. % of crude steel; binary alkalinity of slag liquid is 1.3-2.0.

11. The method according to claim 9, wherein in the direct steelmaking device, the steelmaking pool is a cylindrical or polygonal prism cylinder, and an upper part of the steelmaking pool is directly connected with the fast reduction area, the steel outlet is provided on a first side near a bottom of the molten steel layer of the steelmaking pool, and the slag outlet is provided on a second side near the molten steel layer of the liquid slag layer.

12. The method according to claim 9, wherein in the direct steelmaking device, the slag flux pile is a solid slag flux pile with an arc conical shape; the solid slag flux pile is a conical pile, formed by mixing at least one type of granular or block limestone, quicklime, blue charcoal, fluorite, dolomite, and block coal with a particle size of 5-50 mm and naturally falling;
the solid slag flux pile passes through the liquid slag layer, and suspended in the molten steel layer.

13. The method according to claim 9, wherein in the direct steelmaking device, the gas making tower is provided with the gas making gun and a reducing airflow channel, forming a conical or pyramid platform;
the gas making gun is externally connected with the oxygen supply device and the gas making raw material supply device, and flame temperature of the gas making gun reaches 1800-2400° C.; an outlet of the reducing airflow channel of the gas making tower is connected with the lower part of the fast reduction area.

14. The method according to claim 13, wherein in the direct steelmaking device, the reducing airflow channel is bell-mouth shaped, with a downward inclination angle of 30°-60° from horizontal plane; an inclination angle with a centripetal axis is 1°-16° to right in a northern hemisphere and 1°-16° to left in a southern hemisphere.

15. The method according to claim 9, wherein in the direct steelmaking device, the fast reduction area is an area for reducing iron containing powder, with a structure of a cylindrical shape with a variable cross-section, wherein the structure of the cylindrical shape is thin in middle and thick at upper and lower ends; at least three gas making towers are arranged along a circumference at the lower part of the fast reduction area.

16. The method according to claim 9, wherein in the direct steelmaking device, the ore feeding area is a cone platform with a large bottom and a small top, and the exhaust gas outlet is provided in the center of the top part of the ore feeding area; the plurality of slag flux feeding ports are arranged along the circumference on the outer side of the exhaust gas outlet; at least two ore feeding ports are provided on an outer side of the ore feeding area, and the outer side of the ore feeding area is uniformly provided with at least two cold air ports, the interior of the ore feeding area is provided with the slag flux bin and the slag flux feeding mechanism.

17. The method according to claim 9, wherein in the direct steelmaking device, the control system comprises hardware systems and control software, the hardware systems and control software are electrically connected with the direct steelmaking device by the sensors and the control components.
